(19) United States
(12) Patent Application Publication
(10) Pub. No.: US 2026/0153282 A1
(43) Pub. Date: Jun. 4, 2026

(54) REFRIGERATOR

(71) Applicant: LG ELECTRONICS INC., Seoul (KR)

(72) Inventors: Chungseob Lee, Seoul (KR); Hyunwoo Park, Seoul (KR); Wonho Park, Seoul (KR); Namgyo Lee, Seoul (KR)

(73) Assignee: LG ELECTRONICS INC., Seoul (KR)

(21) Appl. No.: 19/403,574

(22) Filed: Nov. 28, 2025

(30) Foreign Application Priority Data
Nov. 29, 2024 (KR) 10-2024-0174403

(51) Int. Cl. F25D 23/02

(52) U.S. Cl. CPC F25D 23/028

(57) ABSTRACT

A refrigerator of the present disclosure includes: a cabinet defining a storage space open forward; a door disposed at a front of the cabinet and configured to open and close the storage space, the door having an accommodation space open to an outside; and an opening module disposed inside the door. The opening module includes: a handle movable upward and downward, the handle including a lifter and an operation part disposed in the accommodation space; a link including a rotating shaft extending in a width direction of the door and defining a center of rotation, a first arm extending downward from the rotating shaft of the link, a lever inclined forward and downward from the first arm and contacting an upper side of the lifter, and a second arm extending upward from the rotating shaft; and a pusher movable forward and backward behind the second arm, and configured to move backward to protrude from a rear surface of the door.

### BACKGROUND OF THE INVENTION

### 1. Field of the Invention

The following disclosure relates to a refrigerator.

### 2. Description of the Related Art

A refrigerator has a storage space that is shielded by a door, and food can be stored in the storage space at a low temperature. The refrigerator may cool the inside of the storage space using cool air generated through heat exchange with a refrigerant circulating in a refrigeration cycle. In recent years, refrigerators are becoming larger and multi-functional with changes of dietary habits and premiumization of products, and refrigerators having various structures and convenience devices for convenience of users and for efficient use of internal spaces are being released.

The storage space of the refrigerator may be opened/closed by the door. Further, the refrigerator may be classified into various types according to the arrangement of storage spaces and the structure of doors that open and close the storage spaces. For example, the doors of the refrigerator may be opened and closed by rotation or inserted or withdrawn by sliding.

A user may open and close the door. The door is difficult to handle if it is large and heavy, or if a pressure difference between the inside and outside the refrigerator is large, and/or if a magnetic force of a door gasket is large. For example, a greater force may be required to open the door, causing inconvenience to the user.

Korean Laid-open Patent Publication No. 10-2024-0052562 (hereinafter referred to as Patent Publication No. 562) discloses a refrigerator with a door opening device. The door opening device disclosed in Patent Publication No. 562 includes a handle lever rotatably coupled to a door cap, a slider disposed at the rear of the handle lever so as to be linearly movable upward and downward by the handle lever, and a pusher coupled to the rear of the slider so as to be linearly movable forward and backward.

In recent living environments, a cabinet to accommodate a refrigerator is provided or a refrigerator is placed next to other furniture. The existing refrigerator with a thick door has a problem in that its thickness in the front-rear direction is larger than the thickness of a refrigerator cabinet or other furniture, such that the refrigerator protrudes more forwardly than other furniture, causing inconvenience to users, and adversely affecting the interior design.

In consideration of the above problem, there is a growing demand for a refrigerator including a door with reduced thickness. However, the door opening device disclosed in Patent Publication No. 562 or door opening devices applied to existing refrigerators are difficult to be mounted to a thin door.

### SUMMARY OF THE INVENTION

It is an objective of the present disclosure to solve the above and other problems.

It is another objective of the present disclosure to provide a refrigerator including an opening module that opens a door.

It is yet another objective of the present disclosure to provide a refrigerator including an opening module having a small volume.

It is yet another objective of the present disclosure to provide a refrigerator including an opening module that is mounted to a door thinner than existing doors.

It is yet another objective of the present disclosure to provide a refrigerator allowing a user to open a door by moving a handle upward.

It is yet another objective of the present disclosure to provide a refrigerator having a sufficient space for a user's hand to fit into a handle of an opening module.

It is yet another objective of the present disclosure to provide a refrigerator capable of preventing interference between a handle and a pusher of an opening module.

The objectives of the present disclosure are not limited to the aforementioned objectives and other objectives not described herein will be clearly understood by those skilled in the art from the following description.

In accordance with an aspect of the present disclosure, the above and other objectives can be accomplished by providing a refrigerator including a cabinet defining a storage space, a door opening and closing the storage space, and an opening module provided inside the door.

The storage space may be opened forward.

The door may be disposed at a front of the cabinet and configured to open and close the storage space.

The door may have an accommodation space opened to an outside.

The opening module may be disposed inside the door.

The opening module may include: a handle movable upward and downward; a link rotatable about a center of rotation disposed in a width direction of the door; and a pusher movable forward and backward.

The handle may include an operation part and a lifter.

The operation part may be disposed in the accommodation space.

The link may include a rotating shaft extending in the width direction of the door and defining the center of rotation of the link.

The link may include a lever inclined forward and downward and contacting an upper side of the lifter.

The link may include a first arm extending downward from the rotating shaft, and a second arm extending upward from the rotating shaft.

The lever may extend from the first arm.

The pusher may be movable forward and backward behind the second arm. The pusher may move backward to protrude from a rear surface of the door.

The handle and the link may overlap each other in the width direction of the door. The handle and the center of rotation of the link may overlap each other in the width direction of the door. The operation part and the link may be spaced apart from each other in the width direction of the door. That is, when viewed from a side, the handle, the link, and the center of rotation of the link may overlap each other.

The handle may further include: a body extending downward from the operation part; and a handle arm disposed below the operation part and extending outward in the width direction of the door from the body.

The rotating shaft of the link may be disposed in the width direction of the door.

A length of the rotating shaft of the link in the with direction of the door may be greater than a width of the first arm.

The handle may further include a step portion protruding forward from the handle arm. The lifter may protrude outward in the width direction of the door from the step portion.

The opening module may further include a stopper disposed at an upper side of the operation part and configured to restrict upward movement of the handle.

The link may further include a protrusion protruding rearward from the second arm to contact the pusher.

The opening module may further include a case disposed inside the door and configured to accommodate the handle and the link.

The door may further include: a front panel defining a front surface of the door; and an opening formed in the front panel and communicating with the accommodation space.

The case may cover the opening from the inside of the door.

The opening module may further include an elastic member pressing the pusher forward.

The pusher may include: an inner portion having an accommodation portion in which the elastic member is disposed; an outer portion protruding rearward from the rear surface of the door when the pusher moves backward; and an extension portion extending from the inner portion to the outer portion.

The elastic member may be disposed between the case and the accommodation portion.

The lever may include an insertion portion.

The lifter may be inserted into the insertion portion.

The insertion portion may extend forwardly and downwardly. The insertion portion may be recessed from an inside to an outside of the lever. The inside of the insertion portion may face inward in the width direction of the door.

The lifter may be disposed at a front end of the insertion portion when no external force is applied to the opening module.

In accordance with another aspect of the present disclosure, the above and other objectives can be accomplished by providing a refrigerator including: a cabinet defining a storage space openforward; a door disposed at a front of the cabinet and configured to open and close the storage space; and an opening module disposed inside the door.

The opening module may include: a handle movable upward and downward; a link rotatable about a center of rotation disposed in a width direction of the door upon upward and downward movement of the handle; and a pusher movable forward and backward upon rotation of the link, and configured to move backward and protrude from a rear surface of the door.

When viewed from a side, the handle and the link may overlap each other.

The handle may include a lifter disposed below the link, and the link may include a lever disposed above the lifter and inclined forward and downward.

The handle may include an operation part accessible from an outside, wherein when viewed from a side, the operation part and the link may overlap each other and may be spaced apart from each other in the width direction of the door.

Other detailed matters of the exemplary embodiments are included in the detailed description and the drawings.

### Effects of the Invention

According to at least one of the embodiments of the present disclosure, a refrigerator including an opening module that opens a door may be provided.

According to at least one of the embodiments of the present disclosure, a refrigerator including an opening module having a small volume may be provided.

According to at least one of the embodiments of the present disclosure, a refrigerator including an opening module that is mounted to a door thinner than existing doors may be provided.

According to at least one of the embodiments of the present disclosure, a refrigerator allowing a user to open a door by moving a handle upward may be provided.

According to at least one of the embodiments of the present disclosure, a refrigerator having a sufficient space for a user's hand to fit into a handle of an opening module may be provided.

According to at least one of the embodiments of the present disclosure, a refrigerator capable of preventing interference between a handle and a pusher of an opening module may be provided.

### BRIEF DESCRIPTION OF THE DRAWINGS

FIG. 1 is a perspective view of a refrigerator according to an embodiment of the present disclosure;

FIG. 2 is an exploded perspective view of a door illustrated in FIG. 1;

FIG. 3 is a diagram illustrating an opening module and a cap illustrated in FIG. 2 that are mounted to a door;

FIG. 4 is an exploded perspective view of a portion of an opening module of a refrigerator according to a first embodiment of the present disclosure;

FIG. 5 is a perspective view of a handle, a link, and a pusher illustrated in FIG. 4;

FIG. 6 is conceptual diagrams illustrating an operation of a door and an opening module of the refrigerator according to the first embodiment of the present disclosure in which FIG. 6(a) is a cross-sectional view taken along line 6a-6a in FIG. 1, and FIG. 6(b) is a cross-sectional view taken along line 6b-6b in FIG. 1;

FIG. 7 is a cross-sectional view illustrating a state in which the opening module shown in FIG. 6 is displaced by an external force, in which FIG. 7(a) is a cross-sectional view taken along line 6a-6a in FIG. 1, and FIG. 7(b) is a cross-sectional view taken along line 6b-6b in FIG. 1;

FIG. 8 is a cross-sectional view illustrating a state in which the door is opened by a forward external force applied to the opening module shown in FIG. 7;

FIG. 9 is a conceptual diagram illustrating an operation of a door and an opening module of a refrigerator according to a second embodiment of the present disclosure, in which FIG. 9(a) illustrates a state in which no external force is applied, and FIG. 9(b) illustrates a state in which an upward external force is applied to the opening module; and

FIG. 10 is a conceptual diagram illustrating an operation of a door and an opening module of a refrigerator according to a third embodiment of the present disclosure, in which FIG. 10(a) illustrates a state in which no external force is applied to the opening module, FIG. 10(b) illustrates a state in which a handle and a link are moved by an external force, and FIG. 10(c) illustrates a state in which the door is opened by a forward external force applied to the handle;

FIG. 11 is a perspective view of a refrigerator according to another embodiment of the present disclosure.

### DETAILED DESCRIPTION OF THE PREFERRED EMBODIMENTS

Hereinafter, the present disclosure will be described in detail with reference to the accompanying drawings, in which the same reference numerals are used throughout the drawings to designate the same or similar components, and a redundant description thereof will be omitted.

The suffixes, such as “module” and “unit,” for elements used in the following description are given simply in view of the ease of the description, and do not have a distinguishing meaning or role.

In addition, it will be noted that a detailed description of known arts will be omitted if it is determined that the detailed description of the known arts can obscure the embodiments of the present disclosure. Further, the accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that, although the terms first, second, etc., may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

A singular representation may include a plural representation unless context clearly indicates otherwise.

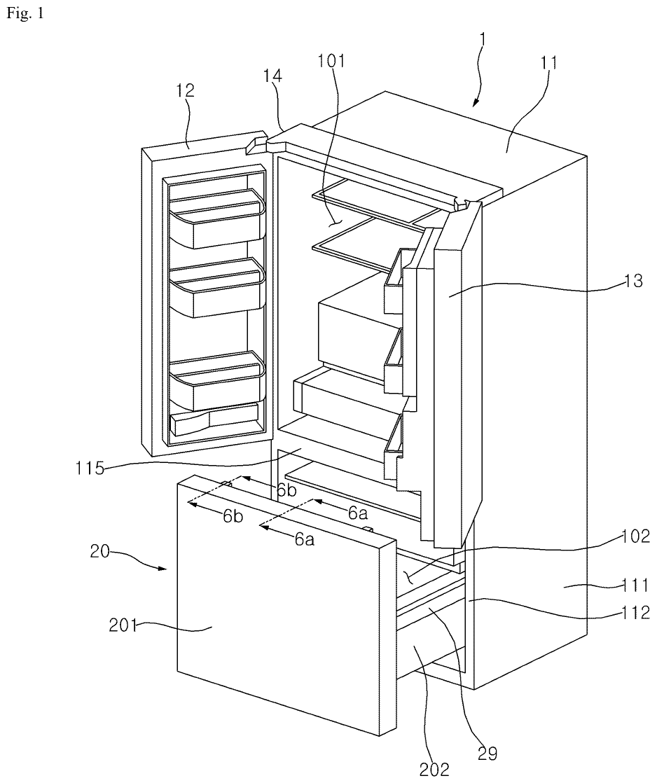

Referring to FIG. 1, a refrigerator 1 includes a cabinet 11 defining storage spaces 101 and 102. The storage spaces 101 and 102 may be provided in the cabinet 11. The storage spaces 101 and 102 may be opened forward. Hereinafter, the storage spaces 101 and 102 may be referred to as storage chambers 101 and 102. Hereinafter, the interior of the storage chambers 101 and 102 may be referred to as the interior of the refrigerator.

The refrigerator 1 includes doors 12, 13, and 20 that open and close the storage spaces 101 and 102.

A plurality of storage chambers 101 and 102 may be provided, one of which is provided as a refrigerating compartment, and the other one is provided as a freezing compartment. For example, a first storage chamber 101 may be provided at an upper side and a second storage chamber 102 may be provided at a lower side. For example, the first storage chamber 101 may be provided as a refrigerating compartment, and the second storage chamber 102 may be provided as a freezing compartment.

The following description will be made using a bottom freezer type refrigerator having the freezing compartment provided at a lower side thereof as an example, but the present disclosure may also be applied to other types of refrigerators.

The refrigerator 1 may include a partition part 115 that partitions the first storage chamber 101 and the second storage chamber 102. The partition part 115 may vertically partitions the first and second storage chambers 101 and 102.

The above configuration of storage chambers is exemplary, and the present disclosure is not limited thereto. For example, the second storage chamber 102 may be provided as a refrigerating compartment. Alternatively, the first and second storage chambers may be provided side-by-side.

The doors 12, 13, and 20 may include a first door 12 and 13 for opening and closing the first storage chamber 101, and a second door 20 for opening and closing the second storage chamber 102.

The first door may rotate about a hinge 14 as a support axis. The first door 12 and 13 may include a left door 12 and a right door 13.

The second door 20 may be slidably mounted to the cabinet 11. The second storage chamber 102 may be opened and closed by insertion and withdrawal of the second door 20. The second door 20 may include a door part 201 that opens and closes the second storage chamber 102, and a basket 202 disposed on a rear surface of the door part 201. A rail 29 may be disposed at the rear of the second door. The rail may guide insertion and withdrawal of the second door.

The second door 20 may be referred to as a drawer type door 20. The refrigerator may include different types of opening/closing doors. The refrigerator may include a combination of various types of opening/closing doors. An opening module and the like of the present disclosure may be applied to different types of doors.

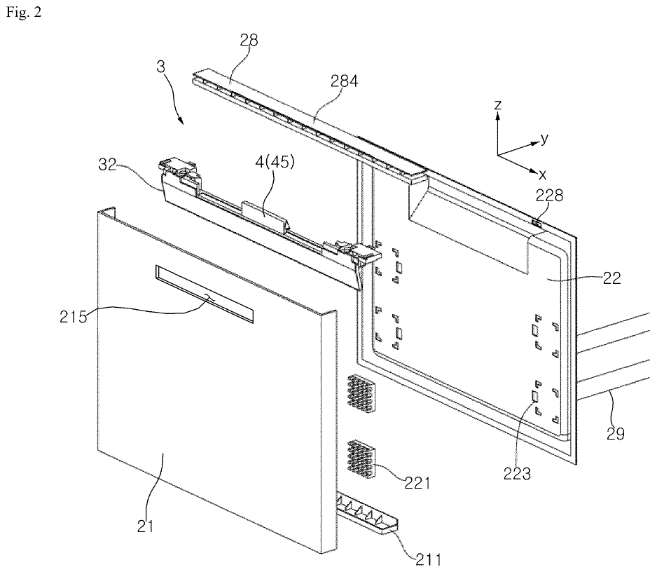

The first door 12 and 13 may be provided with an opening module 3 (see FIG. 2). The second door 22 may be provided with the opening module 3. An external force may be applied to the opening module 3. A user may operate the door by using the opening module 3. By operating the opening module 3, the doors 12, 13, and 20 may be withdrawn from the storage chambers 101 and 102. For example, the opening module 3 may open the door by overcoming the weight of the door, pressure difference between the interior and exterior of the refrigerator, and/or attraction force of a gasket. In this case, the opening of the door may refer to initial opening. The gasket 111 may include a magnetic substance, and the attraction force may refer to a magnetic force. Alternatively, the gasket 111 may seal a gap between the door 20 and the cabinet 11, and the attraction force may be an attraction force generated due to a pressure difference between the interior and exterior of the storage space of the cabinet 11 when the door 20 opens.

The opening of the door will be described below. The opening of the door may include initial opening and later opening. The initial opening may refer to an initial opening state of the door in which the door 20 starts to open. The later opening may refer to an opening state of the door after the initial opening is terminated. The weight of the door may act as a resistance force against the initial opening and the later opening. The resistance force may refer to a force to resist opening of the door so that the door does not open. The pressure difference between the interior and exterior of the refrigerator may greatly act at the beginning of the initial opening. The resistance force due to the pressure difference between the interior and exterior of the refrigerator during the initial opening of the door may rapidly disappear. The magnetic force of the gasket may be applied to the entire door during the initial opening of the door. The magnetic force of the gasket may gradually decrease over the entire period of the initial opening.

The opening module 3 may provide force for overcoming the resistance force against the initial opening. For example, when the opening module 3 operates, initial opening of the door and the cabinet may be achieved. For example, a user may operate the opening module 3 with a finger to initially open the door. Then, the door may be operated by the user's arm. The user may perform actions, such as touching, holding, pushing, pulling, and/or pressing the opening module 30. An automatic mechanism, which is used instead of the user or is added, may operate the opening module 3. The opening module 3 may be provided at the edge of the first and second doors 12, 13, and 20.

The opening module 3 may be provided at an upper end of the second door 20.

The following description will be made of an example in which the opening module 3 is provided for the second door 20. In the following description, the second door may be preferentially considered. Obviously, the door may be the first door.

Referring to FIG. 2, a left-right direction of the door may be defined as the X-axis direction, and a front-rear direction of the door may be defined as the Y-axis direction. An up-down direction of the door may be defined as the Z-axis direction.

The door 20 may include an outer panel 21 facing the outside of the cabinet 11 and an inner panel 22 facing the storage chamber 102. The outer panel 21 faces forward, and the inner panel 22 faces rearward. The outer panel 21 may be made of a metal material. The inner panel 22 may be made of a resin material. The outer panel 21 may be referred to as a front panel 21. The inner panel 22 may be referred to as a door liner 22.

The front panel 21 may face forward. The front panel 21 may have an opening 215. The opening 215 may be formed at the center in a width direction (left-right direction) of the door 20. The opening 215 may be disposed adjacent to the upper end of the door 200.

The opening module 3 may be exposed forward through the opening 215. The opening module 3 will be described in detail later.

The door 20 may include a rail 29 extending rearward from the inner panel 22. The rail 29 may be fastened to the inner panel 22 by a fastening member. A rail mount 221 may be fastened to the inner panel 22. The inner panel 22 may have a rail recess 223. The rail mount 221 may be aligned with the rail recess 223. The rail mount 221 and the rail 29 may be fastened to each other by the fastening member. The rail 29 and the inner panel 22 may be securely fastened to each other by the rail mount 221. The rail 29 may be firmly fixed to the inner panel by the rail mount 221 even though the thickness (length in the Y-axis direction) of the door is small.

Both side surfaces of the door 20 may be protected by a portion that extends from one of the panels. For example, the outer panel 21 may include side surfaces at both ends of the external panel 21.

The door 20 may include a bottom 211 that protects a lower portion.

The door 20 may include a cap 28 that defines an upper surface.

A portion of the opening module 3 may be exposed forward through the opening 215. The opening module 3 may include an operation part 45, and the operation part 45 may be exposed forward through the opening 215.

A user may operate the operation part 55 through the opening 215. The user may open the door 200 by operating the operation part 55. A user may initially open the door 200 by operating the operation part 55. The user may withdraw the door 200 forward by moving the operation part 55 in a first direction. For example, the user may withdraw the door 200 forward by pulling the operation part 55 forward.

The opening module may include a case 32. The case 32 may be disposed inside the door 20. The case 32 may be disposed between the front panel 21 and the door liner 22. The case 32 may be disposed under the cap 28. The case 32 may be coupled to a lower portion of the cap 28.

The case 32 may accommodate a handle 4. The case 32 may accommodate a link 6 and a pusher 8 which will be described later.

An operation part 45 of the handle 4 may be disposed on the outside of the case 32. Or, the operation part 45 may be disposed inside the case 32 and may be exposed to the outside through the opening 215. A user may access the operation part 45 through the opening 215.

The opening module 3 may include a pusher 8 that pushes the cabinet 11 to open the door 20. The door 20 has an opening formed in a rear surface, and the pusher 8 may move backward through the opening formed in the rear surface of the door 20. An opening 228 may be formed in the door liner 22.

The pusher 8 may be mounted at an upper end or left and right ends of the door.

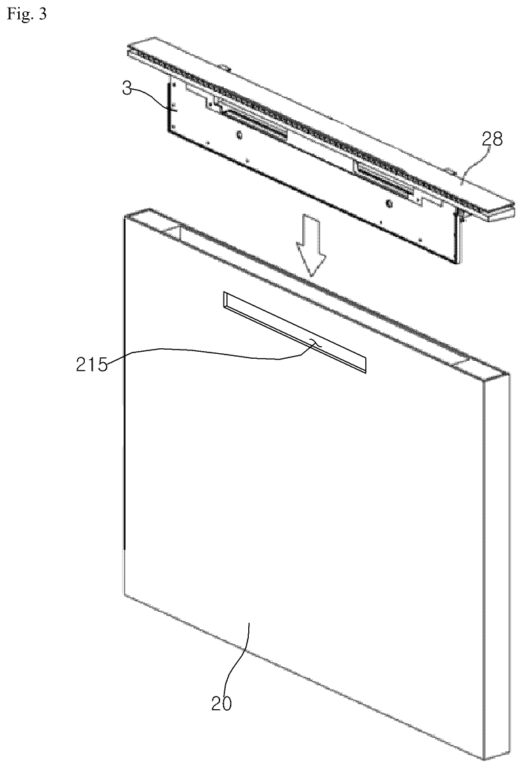

Referring to FIG. 3, the opening module 3 and the cap 28 are fastened to define a first assembly. The outer panel 21, the inner panel 22, and the bottom 211 are fastened to define a second assembly. The first assembly may be fastened to the upper surface of the second assembly.

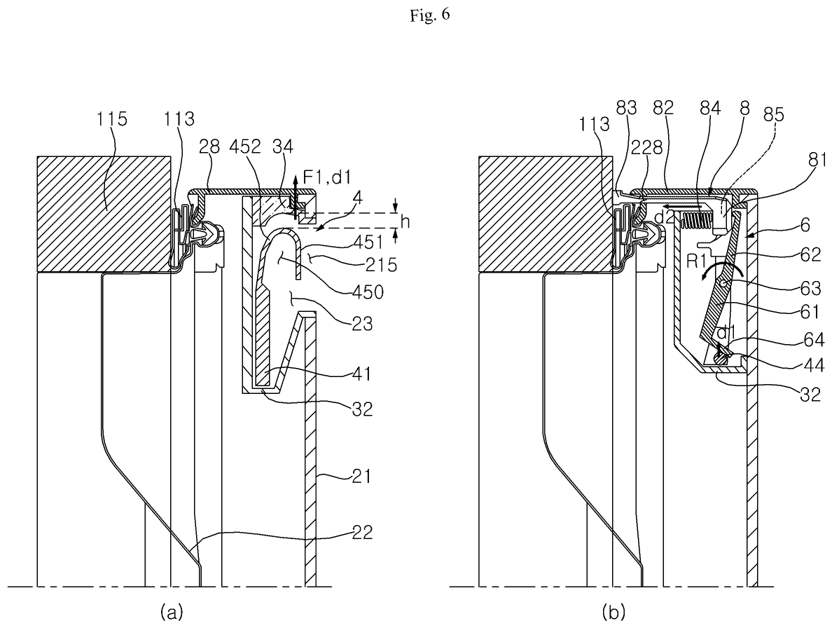

Referring to FIGS. 3 and 6, the case 32 may be inserted into the door 20. The case 32 inside the door 20 may be partitioned into an interior space 23 and an exterior space.

The case 32 may be coupled to the front panel 21 at the opening 215. The case 32 may define the edge of the opening 215. The interior space 23 of the case 32 may communicate with the outside of the door 20 through the opening 215.

The case 32 may cover the opening 215 from the inside of the door 20. The interior space 23 of the case 32 may communicate with the opening 215, and may be separated from a space which is the exterior space of the case 32 and the interior of the door 20.

In the above configuration, an insulation space may be provided inside the door. The interior of the door may be insulated with a foam member and/or an insulation material.

A space between the case 32 of the opening module 3 and the door panel 21 and 22 may be filled with a foam member and/or an insulation material. The interior of the door may be filled with the foam member. The interior space defined by the rear side of the outer panel 21, the front side of the inner panel 22, the outer portion of the case 32, the upper side of the bottom 211, the lower side of the cap 28, and the inside of the side surface of the outer panel 21 may be filled with the foam member. The exterior space of the opening module 3 may be filled with the foam member. The interior space of the opening module 3 may not be filled with the foam member. A space between the case 32 and the outer panel may be filled with the foam member. A space between the case 32 and the inner panel may be filled with the foam member. A space between the case 32 and the bottom may be filled with the foam member. A space between the case 32 and the cap may be filled with the foam member. A space between the opening module 3 and the side surface of the outer panel 21 may be filled with the foam member. The foam member may be made of a resin material, polystyrene (PS), and/or a porous material. A vacuum insulation member may be used instead of or in combination with the foam member.

The cap 28 may be fastened to at least one of the inner panel and/or the outer panel. The cap may be fastened to at least one of the inner panel and/or the outer panel when the opening module 3 is fastened. The cap may be fastened to an upper end of at least one of the inner panel and/or the outer panel. The cap may be fastened to at least one of the inner panel and/or the outer panel via a protrusion and groove arrangement. The inner panel and the outer panel may have upper ends having the same height. The inner panel and the outer panel may not have a recessed portion and/or a protruding portion in the front-rear direction (Y) for fastening the cap. The inner panel and the outer panel may not have a recessed portion and/or a protruding portion in the up-down direction Z for fastening the cap. At least one of a gap between the cap and the inner panel and/or a gap between the cap and the outer panel may be filled with a foam member. The cap and the opening module 3 may be firmly seated in the door by the foam member.

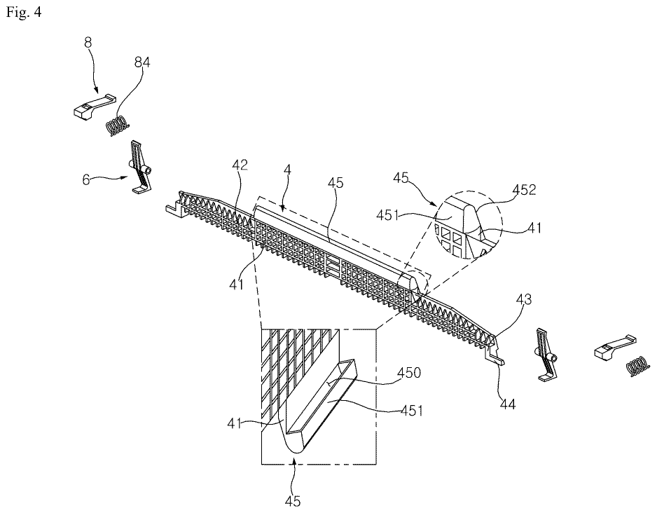

Referring to FIG. 4, the refrigerator 1 may include the opening module 3. The opening module 3 may include the handle 4, the link 6, and the pusher 8. The opening module 3 may include an elastic member 84.

The handle 4 may be movable in a first direction. For example, the handle 4 may be movable upward and downward. The handle 4 may be fixed so as not to be movable in a second direction and a third direction that are orthogonal to the first direction. For example, the handle 4 may be fixed in the left-right direction and the front-rear direction. The handle 4 may be movable upward and downward while being fixed in the front-rear direction and the left-right direction. The handle 4 is restricted from moving forward and backward or moving from side to side by the case 32 or a separate support member, but is movable upward and downward.

The handle 4 may be operated by a user. The handle 4 may be movable in the first direction by a user. The handle 4 may be movable upward and downward by a user.

The handle 4 may include the operation part 45. The operation part 45 may be disposed in the space 23 (see FIG. 6) that is accessible from the outside through the opening 215 (see FIG. 2). The space 23 may be referred to as an accommodation space 23. The accommodation space 23 may be disposed behind the opening 215. The accommodation space 23 may communicate with the opening 215. The accommodation space 23 may be an interior space of the case 32.

The operation part 45 may be exposed forward through the opening 215. A user may operate the operation part 45 through the opening 215. The user may open the door 20 by operating the operation part 45. A user may initially open the door 20 by operating the operation part 45. The user may withdraw the door 20 forward by moving the operation part 45 in the first direction. For example, the user may withdraw the door 20 forward by pulling the operation part 45 upward.

The operation part 45 may include a front surface 451 that faces forward. The front surface 451 may be exposed to the outside through the opening 215.

The operation part 45 may include a rear surface 452 that faces rearward.

The operation part 45 may include a grip 450 that is recessed upward. The grip 450 may be disposed between the front surface 451 and the rear surface 452.

The operation part 45 may be provided at an upper end of a body 41 which will be described below.

The handle 4 may include the body 41. The body 41 may extend downward from the operation part 45. The body 41 may extend downward from the rear surface 452 of the operation part 45.

The operation part 45 and the body 41 may be disposed at a central portion of the door 20 in the width direction of the door 20. However, the operation part 45 is not limited thereto, and may be disposed at a portion other than the central portion. For example, the operation part 45 may be biased to the left or right with respect to the center of the door in the width direction.

The handle 4 may include an arm 42. The arm 42 may extend from the body 41 in the width direction of the door 20. The arm 42 may extend from the body 41 toward both sides thereof. The arm 42 may include a first arm extending from the body 41 toward one side thereof, and a second arm extending from the body 41 toward the other side thereof.

The arm 42 may extend from a position spaced apart from the operation part 45. The arm 42 may be vertically spaced apart from the operation part 45. The arm 42 may be downwardly spaced apart from the operation part 45.

The handle 4 may include a lifter 44. The lifter 44 may protrude from the arm 42 of the handle. The lifter 44 may extend rearward or outward in the width direction of the door from the arm 42 of the handle.

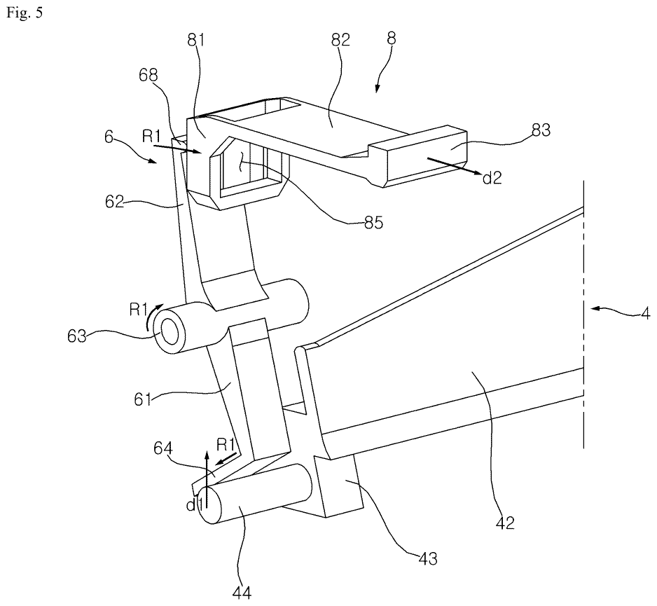

The arm 42 may include a step portion 43. The lifter 44 may protrude from the step portion 43. The step portion 43 will be described in detail later with reference to FIG. 5.

The link 6 may be rotatable. The link 6 may be rotatable about a rotating shaft 63 disposed in the width direction of the door. The rotating shaft 63 of the link 6 may be supported by the case 32 (see FIG. 6).

The rotating shaft 63 of the link 6 may be formed as one body with the body 61 and 62 of the link 6. The rotating shaft 63 may protrude from the body 61 and 62. The rotating shaft 63 may protrude from the body 61 and 62 in the width direction of the door 20. The case 32 may support the rotating shaft 63. The case 32 may rotatably support the rotating shaft 63.

Unlike the above example, the body 61 and 62 of the link 6 may be provided separately from the rotating shaft 63. The rotating shaft 63 may pass through the body 61 and 62. The rotating shaft 63 may rotate integrally with the body 61 and 62. The case 32 may support the rotating shaft 63. The case 32 may rotatably support the rotating shaft 63.

Unlike the above example, the body 61 and 62 of the link 6 may be provided separately from the rotating shaft 63, and the body 61 and 62 may rotate about the rotating shaft 63. The rotating shaft 63 may pass through the body 61 and 62. The case 32 may support the rotating shaft 63. The case 32 may rotatably support the rotating shaft 63. Alternatively, the rotating shaft 63 may be fixed to the case 32, and thus may not rotate.

The link 6 may be rotated by the handle 4.

The pusher 8 may be movable forward and backward. The pusher 8 may protrude rearward from the door 20 to press the cabinet 11 backward. The cabinet 11 may be considered to be fixed based on the weight, installation position, and the like. Accordingly, when the pusher 8 pushes the cabinet 11 backward, the door 20 may be opened forward.

The pusher 8 may be moved backward by the link 6.

The opening module 3 may include an elastic member 84 that presses the pusher 8 forward. When the pusher 8 moves backward, the elastic member 84 is compressed to apply an elastic force to the rear of the pusher 8. When the external force is removed, the pusher 8 may move forward.

The link 6 and the pusher 8 may include a first link and a first pusher that are disposed at one end of the handle 4 and a second link and a second pusher that are disposed at an opposite side end of the handle 4.

Referring to FIG. 5, the arm 42 of the handle may include a step portion 43. The step portion 43 may protrude from a rear surface of the arm 42 of the handle. The step portion 43 may protrude rearward from the rear surface of the arm 42 of the handle. The step portion 43 may extend downward.

The lifter 44 may protrude from the step portion 43. The lifter 44 may protrude from a lower end of the step portion 43.

The lifter 44 may protrude outward in the width direction of the door from the step portion 43. The lifter 44 may be disposed in a direction parallel to the arm 42 of the handle.

Accordingly, the door 20 may have more space in which an insulation material is filled. For example, the case 32 may be recessed further upward than the step portion 43, which is a portion corresponding to the lower side of the body 41 and the arm 42, and a portion corresponding to the lower side of the lifter 44. More space for the insulation material may be secured in the lower part of the exterior of the case 32 and the interior space of the door 20 may be secured.

Accordingly, it is possible to prevent interference between the link 6 and the handle 4. A position of the rotating shaft of the link 6 is fixed, such that even when the handle 4 moves, the link 6 and the handle 4 may not interfere with each other.

The link 6 may be rotatably disposed. The center of rotation of the link 6 may be located in the width direction of the door.

The link 6 may include the rotating shaft 63 that defines the center of rotation. The rotating shaft 63 of the link may be located in the width direction of the door. The rotating shaft 63 of the link 6 may be supported by the case 32 (see FIG. 6).

The link 6 may be disposed between the handle 4 and the pusher 8. The link 6 may be rotatably disposed between the handle 4 and the pusher 8. The link 6 may be disposed between the lifter 44 and the pusher 8. The link 6 may extend vertically.

The link 6 may vertically overlap at least a portion of the handle 4. The link 6 may be disposed at an upper side of the lifter 44. The link 6 and the lifter 44 may contact each other.

The link 6 may be rotated by the lifter 44. The link 6 may be rotated when the lifter 44 moves in a first direction d1. For example, the link 6 may be rotated when the lifter 44 moves in an upward direction d1. The link 6 may be rotated in a first rotation direction R1 when the lifter 44 moves in the first direction d1. For example, when the lifter 44 moves in the upward direction d1, the link 6 may rotate in a direction R1 in which an upper portion 61 (first arm) of the link 6 moves backward and a lower portion 62 (second arm) of the link 6 moves forward.

The link 6 may include the first arm 61 that extends toward the lifter 44. The first arm 61 may extend from the rotating shaft 63. The first arm 61 may extend downward.

The link 6 may include a lever 64 that extends from the first arm 61. The lever 64 may extend from a lower end of the first arm 61.

The lever 64 may extend in a direction intersecting the first arm 61. The lever 64 may be disposed opposite the pusher 8 with respect to the arms 61 and 62 of the link 6. For example, as illustrated in FIG. 5, the pusher 8 may be located on a clockwise side of the second arm, and the lever 64 may be located on a clockwise side of the first arm.

The lever 64 may extend forward from the first arm 61. The lever 64 may extend obliquely and downwardly toward the front.

The lever 64 may be disposed at an upper side of the lifter 44. The lever 64 may contact the lifter 44.

The rotating shaft of the link 6 may be fixed in a first direction. For example, the rotating shaft 63 may be fixed in the up-down direction. Accordingly, when a force is applied to the link 6 in the first direction, the force applied to the link 6 may act as a torque for rotating the link 6 without moving the link upward and downward. For example, when the handle 4 moves upward, the rotating shaft 63 of the link 6 may not move upward and downward, but the first and second arms 61 and 62 of the link 6 may rotate.

In addition, the rotating shaft 63 of the link 6 may also be fixed in the front-rear direction. Further, the rotating shaft 63 of the link 6 may also be fixed in the left-right direction. That is, the link 6 is fixed in the front-rear direction and the left-right direction, and is only rotatable.

When the lifter 44 moves in the first direction d1 toward the link 6, the link 6 may be rotated by the inclination of the lever 64. More specifically, the rotating shaft 63 is fixed in the first direction, such that when the lifter 44 moves in the first direction d1 toward the link 6, an upper portion of the lever 64 gradually comes into contact with the lifter 44 so that a distance between the rotating shaft 63 and the lifter 44 decreases, and the link 6 is rotated in the first rotation direction R1. For example, when the lifter 44 moves upward, the link 6 may be rotated by the inclination of the lever 54. When the lifter 44 moves upward, the link 6 may be rotated so that the lever 64 may move forward.

The link 6 may include the second arm 62 that extends toward the pusher 8. The second arm 62 may extend from the rotating shaft 63. The second arm 62 may extend upward.

The second arm 62 may contact the pusher 8. The second arm 62 may contact an inner end 81 of the pusher 8. An upper end of the second arm 62 may be disposed at the front of the pusher 8.

The second arm 62 may include a protrusion 68 facing the pusher 8. The protrusion 62 may contact an inner portion 81 of the pusher 8.

The length of the rotating shaft 63 of the link in the width direction of the door may be greater than the width of the first arm 61. The length of the rotating shaft 63 of the link in the width direction of the door may be greater than the width of the second arm 62 which will be described later. The rotating shaft 63 of the link may protrude inward and outward from the arms 61 and 62 in the width direction of the door.

The pusher 8 may include an outer portion 83 that is disposed at a rear end thereof. The outer portion 83 may protrude rearward from the door 20. The outer portion 83 may protrude rearward from the door 20 when the pusher 8 moves backward. The outer portion 83 may contact the cabinet 11.

The pusher 8 may include an inner portion 81 disposed at the front side, and an extension portion 82 that extends from the inner portion 81 to the outer portion.

The pusher 8 may include an accommodation portion 85 that accommodates the elastic member 84. The accommodation portion 85 may be recessed forward from the inner portion 81. That is, the accommodation portion 85 may be disposed at the front of the inner portion 81.

When the handle 4 moves upward, the link 6 rotates so that the lever 64 moves forward and the second arm 62 moves backward, and the pusher 8 may move backward.

FIG. 6 illustrates the opening module 3 and the partition part 115 that are disposed inside the door part 201 when the door 20 closes the storage chamber 102, in which (a) of FIG. 6 illustrates a cross-sectional view of a central portion of the door part 201, illustrated in FIG. 1, along with the partition part 115, and (b) of FIG. 6 illustrates a cross-sectional view of the door part 201 at a position of the pusher 8 along with the partition part 115.

Referring to FIG. 6, a gasket 113 may be provided on a rear surface of the door part 201. For example, the gasket 113 may be coupled to the door liner 22.

The gasket 113 may be disposed between the rear surface of the door part 201 and the cabinet 11. An upper portion of the gasket 113 may contact the partition part 115, and a side portion thereof may contact a front end 112 of a side wall 111 of the cabinet 11.

The gasket 113 may seal a gap between the storage chamber 102 and the door 20 so as to prevent leakage of cold air of the storage chamber 102 when the door 20 is closed.

The pusher 83 may be disposed outside a region surrounded by the gasket 113. The pusher 83 may be disposed above the gasket 113.

The opening module 3 may be disposed inside the door 20. The opening module 3 may be disposed inside the door part 201. That is, the opening module 3 may be disposed between the front panel 21 and the door liner 22. The operation part 45 of the opening module 3 may be exposed to the outside through the opening 215. The pusher 8 may be exposed to the outside through an opening 238 formed in the rear surface of the door part 201. The outer portion 83 of the pusher 8 may protrude rearward from the rear surface (the door liner 22) of the door part 201.

The pusher 8 may vertically overlap the lifter 44. The pusher 8 may vertically overlap the lifter 44 when viewed from the side. The pusher 8 and the lifter 44 may be disposed at positions corresponding to each other in the front-rear direction. The inner portion 81 of the pusher 8 and the lifter 44 may be disposed at positions corresponding to each other in the front-rear direction.

The pusher 8 may be disposed at a height corresponding to the operation part 45. The pusher 8 may be spaced apart from the operation part 45 in the width direction of the door. The pusher 8 and the operation part 45 may overlap in the width direction of the door. That is, the pusher 8 may overlap the operation part 45 when viewed from the side. At least a portion of the pusher 8 may overlap the operation part 45 in the width direction of the door. The inner portion 81 and the operation part 45 may overlap each other in the width direction of the door.

As described above, the pusher 8 may be spaced apart from the operation part 45 in the width direction of the door.

In this manner, the pusher 8 and the operation part 45 may be disposed in a small space in the front-rear direction. Further, in this manner, the thickness in the front-rear direction of the opening module 3 may be reduced, and the thickness of the door part 201 may be reduced.

The opening module 3 may initially open the door.

The body 41, the arm 42, and the lifter 44 may be formed as one body. The operation part 45 may be fixed to the body 41 or may be formed as one body with the body 41. The step portion 43 may be formed as one body with the arm 42.

When a user moves the operation part 45 in the first direction d1, the lifter 44 may also move in the first direction. For example, when the user moves the operation part 45 upward, the lifter 44 may also move upward.

The first arm 61 and the second arm 62 may integrally rotate about the rotating shaft 63. When the operation part 45 is moved upward by an external force F1 (see (a) of FIG. 6), the lifter 44 pushes the lever 64 of the link 6 upward, and the link 6 may rotate in the first rotation direction R1 (see (b) of FIG. 6) so that the first arm 61 and the lever 64 are moved forward by the inclination of the lever 64 and the second arm 62 moves backward.

When the link 6 rotates in the first rotation direction R1, the second arm 62 applies force to the inner portion 81 of the pusher 8 in a rearward direction. The second arm 62 may include the protrusion 68, and when the link 6 rotates in the first rotation direction R1, the protrusion 68 applies force to the inner portion 81 of the pusher 8 in a rearward direction.

The outer portion 83 of the pusher 8 may be in contact with the cabinet 11 (or the partition part 115) when the door 20 closes the storage space 102 and no external force is applied to the handle 4, or the pusher 8 may be spaced apart or separated from the partition part 115 when no external force is applied to the handle 4, and when an external force is applied to the operation part 45, the pusher 8 moves backward to contact the partition part 115.

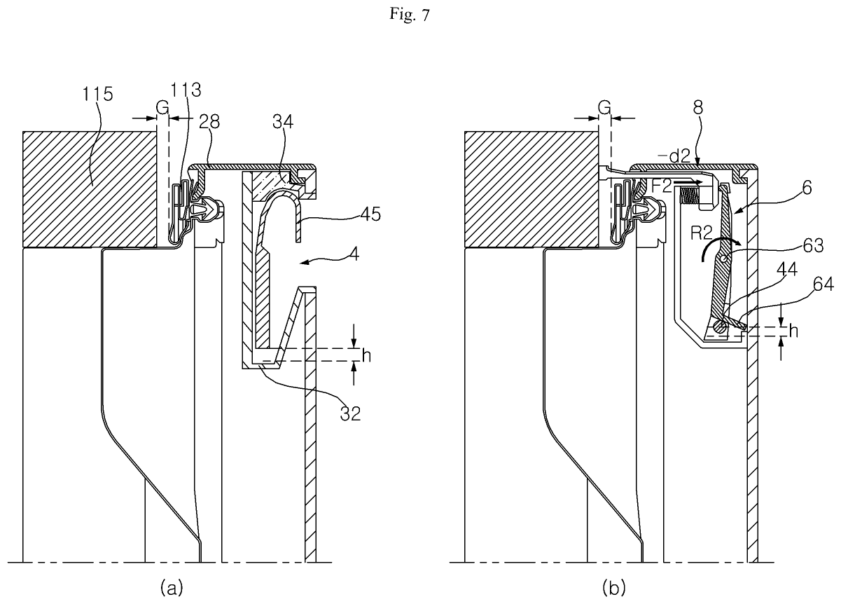

In this state, when the external force F1 is applied to the operation part 45, the handle 4 moves upward (h in FIG. 7) and the pusher 8 moves in a second direction d2. For example, the pusher 8 may move backward. The pusher 8 moves toward the rear 82 and pushes the cabinet (e.g., the partition part 115), such that the door 20 may be withdrawn forward as illustrated in FIG. 7. When the door 20 is withdrawn, the gasket 113 is separated from the partition part 115 (G of FIG. 7). In this manner, the door is initially opened as described above.

The elastic member 84 may be disposed between the case 32 and the accommodation portion 85 of the pusher 8. Alternatively, the elastic member 84 may also be disposed between the doors 21, 22, and 28 and the accommodation portion 85.

The opening module 3 may include a stopper 34. The stopper 34 may be disposed at an upper side of the handle 4. The stopper 34 may be disposed at an upper side of the operation part 45.

The stopper 34 may have a shape corresponding to the operation part 45. For example, the operation part 45 may be convex upward, and the stopper 34 may have an upwardly recessed structure. However, the structure of the stopper 34 is not limited thereto.

Alternatively, the stopper 34 may be made of an elastic body, such as silicone, rubber, or sponge. In this case, a lower surface of the stopper 34 may not correspond to a lower surface of the operation part 45.

When no external force is applied to the opening module 3, the operation part 45 may be spaced a distance (h1) below the stopper 34. Accordingly, the operation part 45 may move upward by a separation distance h1. A user may move the operation part 45 by applying the force F1 to the operation part 45 in the first direction d1, and may move the operation part 45 by the separation distance h1.

Referring to FIG. 7, when the handle 4 moves upward by a predetermined distance h, the operation part 45 may contact the stopper 34 (see (a) of FIG. 7). The upward movement of the handle 4 may be restricted by the stopper 34.

When the pusher 8 moves in the second direction d2 (e.g., rearward direction), the elastic member 84 may apply pressure F2 in an opposite direction −d2 (e.g., forward direction) of the second direction.

When the external force F1 (see FIG. 6) applied to the operation part 45 is removed, the pusher 8 may be moved in the opposite direction −d2 of the second direction by the elastic force F2 of the elastic member 84. For example, when the external force F1 (see FIG. 6) applied to the operation part 45 is removed, the pusher 8 may be moved in the forward direction −d2 by the elastic force F2 of the elastic member 84. When the pusher 8 moves in the forward direction −d2, the link 6 rotates about the rotating shaft 63 in a second rotation direction R2 opposite to the first rotation direction R1. When the external force F1 applied to the operation part 45 is removed, the handle 44 may move downward by gravity, or the lever 64 presses the lifter 44 so that the handle 44 may move downward.

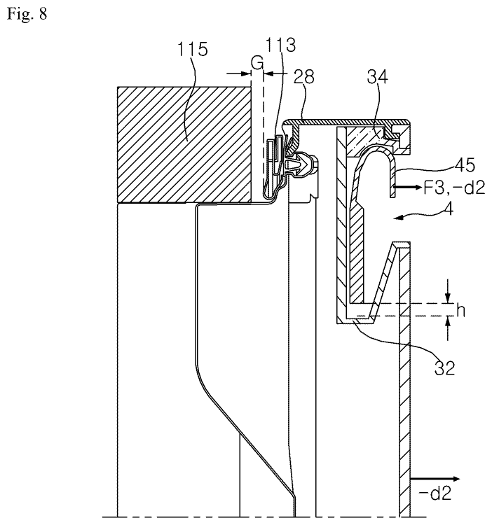

Referring to FIG. 8, unlike the above example described above with reference to FIG. 7, by applying an external force F3 to the operation part 45 in the opposite direction −d2 (e.g., forward direction) when the door 20 is initially opened, an attraction force to a magnetic substance, pressure difference, and the like may be removed, such that the door 20 may be easily withdrawn forward. In this manner, the door is later opened.

In addition, when the handle 4 moves upward, the upward movement of the handle 4 is restricted, thereby allowing a user to easily withdraw the door 20 forward by pulling the operation part 45 forward and upward.

As the handle 4 moves upward and downward, the opening module 3 may occupy a small volume in the front-rear direction, and the thickness of the door part 201 may be reduced.

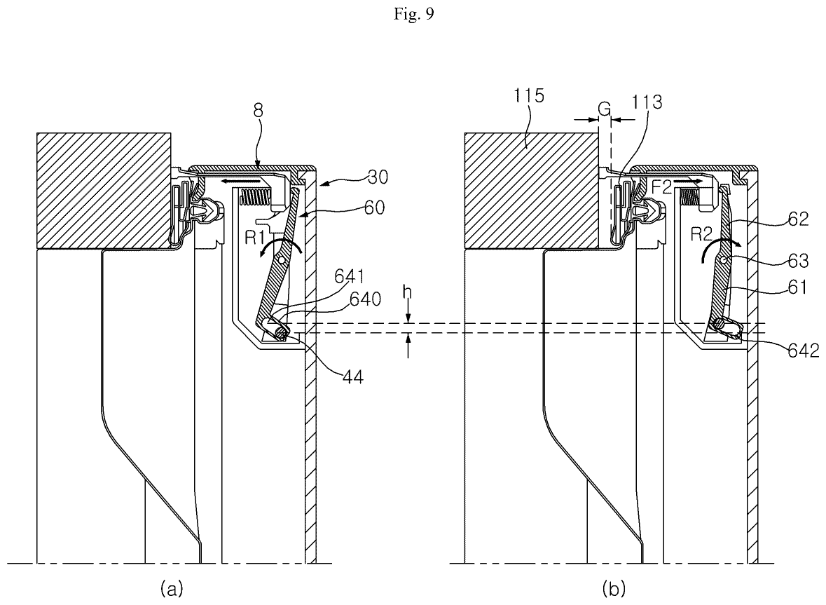

An opening module 30 of a refrigerator according to a second embodiment of the present disclosure will be described below with reference to FIG. 9.

Referring to FIG. 9, except for some features of the refrigerator 1 according to the first embodiment described above, other features may be applied to the refrigerator according to the second embodiment. The description of the first embodiment described above with reference to FIGS. 1 to 8 may be applied to the second embodiment unless otherwise specified, and a redundant description of the same features as those in the above embodiment will be omitted.

Compared to the refrigerator in the first embodiment, the refrigerator according to the second embodiment of the present disclosure is different in the opening module 30. Specifically, compared to the opening module in the first embodiment, the opening module 30 in the second embodiment is different in the structure of a lever 640 of a link 60.

The link 60 includes a first arm 61, a second arm 62, a rotating shaft 63, and a protrusion 68, in the same manner as the link 6 of the first embodiment.

The link 60 includes the lever 640. The lever 640 includes an insertion portion 641 into which the lifter 44 is inserted. The insertion portion 641 may be recessed from the inside to the outside of the lever 640. The inside refers to a portion facing the inside in the width direction of the door, and the outside refers to an outer portion in the width direction of the door.

Alternatively, the insertion portion 641 may pass through the lever 640 in the width direction of the door.

The insertion portion 641 may extend forward and downward. Accordingly, a front end 642 of the insertion portion 641 may be located below a rear end.

The lever 640 may extend forward and downward.

The lifter 44 may be located at the front end 642 of the insertion portion 641 when no external force is applied to the opening module 30.

As explained in the first embodiment, when an external force is applied to the operation part 45, the handle 4 moves upward (h), and the pusher 8 pushes the partition part 115 such that the door 20 may be withdrawn forward. When the door 20 is withdrawn, the gasket 113 and the partition part 115 are separated from each other (G). When the external force applied to the operation part 45 is removed, the pusher 8 may be moved forward by the elastic force F2 of the elastic member 84. When the pusher 8 moves forward, the link 6 may rotate about the rotating shaft 63 in the second rotation direction R2 which is an opposite direction of the first rotation direction R1. When the external force F1 applied to the operation part 45 is removed, the handle 4 may move downward by gravity, or the handle 4 may move downward by the action of the lever 54 and the insertion portion.

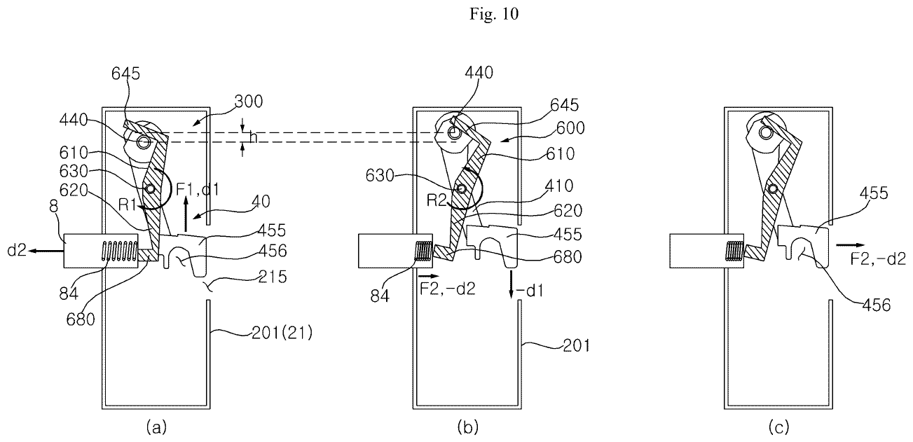

Hereinafter, an opening module 300 of a refrigerator according to a third embodiment of the present disclosure will be described with reference to FIG. 10.

Referring to FIG. 10, except for some features of the refrigerator 1 according to the first embodiment described above, other features may be applied to the refrigerator according to the third embodiment. The description of the first embodiment described above with reference to FIGS. 1 to 8 may be applied to the third embodiment unless otherwise specified, and a redundant description of the same features as those in the above embodiment will be omitted.

Compared to the refrigerator in the first embodiment, the refrigerator according to the third embodiment of the present disclosure is different in the opening module 300. Specifically, the structure of a handle 40 and a link 600 in the opening module 300 according to the third embodiment is different from the structure of the handle 4 and the link 6 in the first embodiment described above.

Compared to the handle 4 in the first embodiment described above, the handle 40 is different in that an operation part 455 is disposed at a lower side, and a lifter 440 is disposed above the operation part 455.

The operation part 455 may include a grip 456 that is recessed upward.

A user may operate the operation part through the opening 215 formed in the front panel 21 of the door part 201. The user may put their hand into the grip 456 through the opening 215 formed in the front panel 21 of the door part 201.

The body 410 may extend upward from the operation part 455. The body 410 may extend upward and rearward from the operation part 455.

The lifter 440 may protrude outward from the upper portion of the body 410 in the width direction of the door 20. As in the first embodiment, an arm is provided on the side of the body 410, and the lifter 440 may protrude from the arm. In addition, as in the first embodiment, the arm has a step portion, and the lifter 440 may protrude from the step portion.

The lifter 440 may be disposed above the operation part 455. The lifter 440 may be disposed behind the operation part 455. The lifter 440 may be positioned in an opposite direction of the first rotation direction R1, which will be described below, with respect to a lever 645 based on the rotating shaft of the link 600.

Accordingly, when the handle 40 moves, the link 600 may be easily rotated in the first rotation direction R1.

The handle 40 may be movable in the first direction. For example, the handle 40 may be movable upward and downward. For example, the handle 40 may be movable upward from a position (position in (a) of FIG. 10) where no force is applied. The handle 40 may move upward by a predetermined distance h.

Similar to the link 6 in the first embodiment, the link 600 includes a first arm 610, a second arm 620, and a rotating shaft 630, and is rotatable about the rotating shaft 630.

The link 600 may include a lever 645 extending from the first arm 610. The lever 645 may extend rearward from the first arm 610. The lever 645 may extend rearward and upward from the first arm 610.

Accordingly, when the lifter 440 moves upward, the link 600 may rotate so that the lever 645 may move forward.

The second arm 620 may be disposed in front of the pusher 8. The second arm 620 may include a protrusion 680. The protrusion 680 may be disposed in front of the pusher 8.

Referring to (a) of FIG. 10, when an external force F1 is applied to the handle 40 in a first direction d1 (e.g., upward direction), the handle 40 may move upward by a predetermined distance h, and the link 600 may rotate the lever 645 in the first rotation direction.

When the link 600 rotates in the first rotation direction, the second arm 620 (or the protrusion 680) may press the pusher 8 in a second direction d2 (e.g., rearward direction), so as to move the pusher 8 in the second direction d2.

When moving in the second direction d2, the pusher 8 presses the cabinet 11, and the door 20 may be withdrawn in an opposite direction −d2 (e.g., forward direction) of the second direction. In this manner, the door is initially opened.

Referring to (b) of FIG. 10, when the external force F1 (see (a) of FIG. 10) applied to the handle 4 is removed, the elastic member 84 may press the pusher 8 in the opposite direction −d2 of the second direction, thereby allowing the pusher 8 to move in the opposite direction −d2 of the second direction.

When the pusher 8 moves in the opposite direction −d2 of the second direction, the link 600 rotates in the second rotation direction R2, opposite to the first rotation direction R1, so that the second arm 620 may move forward.

The handle 40 may move downward by gravity as the external force applied thereto is removed, or as the link 600 rotates in the second rotation direction R2, the lever 645 presses the lifter 440 in a downward direction such that the handle 40 may move downward.

Referring to (c) of FIG. 10, unlike (b) of FIG. 10, when the external force F1 applied to the handle is not removed in the first direction d1, or if an external force F2 is applied to the operation part 455 in the second direction when the external force applied to the handle is removed, the door 2 may be opened in the opposite direction −d2 (e.g., forward direction) of the second direction. In this manner, the door is later opened.

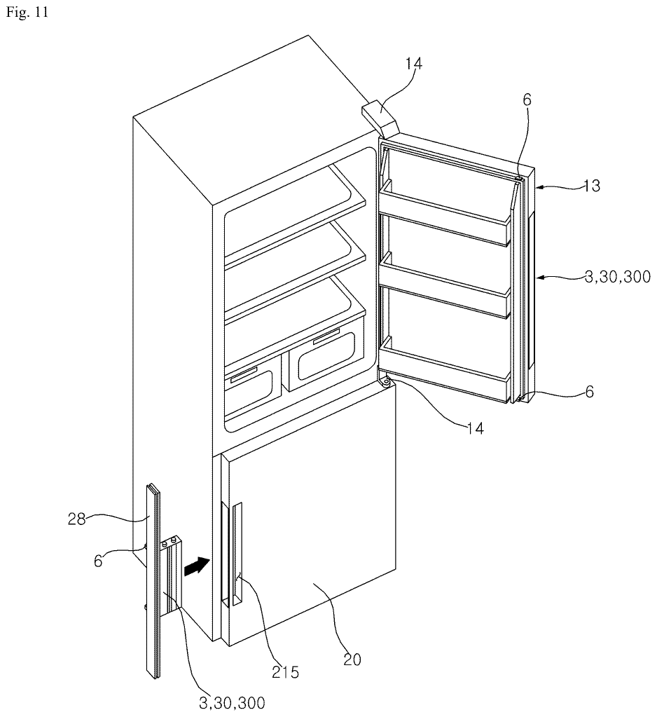

Hereinafter, a refrigerator according to another embodiment of the present disclosure will be described with reference to FIG. 11. The refrigerator in this embodiment may include an opening module 3, 30, and 300.

A second door 20 may rotate about a hinge 14 to open and close a storage chamber. The opening module 3 and 30 may be mounted to the second door 20. The opening module 3 and 30 mounted to the second door 20 may be disposed on an opposite side of the hinge 14.

The opening module 3 and 30 may also be mounted to the first door 13.

The first door 13 may rotate about the hinge 14 to open and close the storage chamber. The opening module 3 and 30 mounted to the first door 13 may be disposed on an opposite side of the hinge 14.

In the first embodiment described above, it is described that the handle 4 is moved in the first direction d1 so that the pusher 8 is moved in the second direction d2, and the door 20 is withdrawn in the opposite direction −d2 of the second direction, in which the first direction d1 is the upward direction, the second direction d2 is the rearward direction, and the forward direction is the opposite direction −d2 of the second direction.

In this embodiment, the first direction may be the opposite direction of the hinge. For example, in FIG. 11, the first direction may refer to the left direction, the second direction may refer to the rearward direction, and the opposite direction of the second direction may refer to a rotation direction in which a portion where the opening module is mounted moves forward.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A refrigerator comprising:
a cabinet defining a storage space open forward;
a door disposed at a front of the cabinet and configured to open and close the storage space, the door having an accommodation space open to an outside; and
an opening module disposed inside the door,
wherein the opening module comprises:
a handle movable upward and downward, the handle including a lifter and an operation part disposed in the accommodation space;
a link including
a rotating shaft extending in a width direction of the door and defining a center of rotation of the link,
a first arm extending downward from the rotating shaft,
a lever inclined forward and downward from the first arm and contacting an upper side of the lifter, and
a second arm extending upward from the rotating shaft; and
a pusher movable forward and backward behind the second arm, and configured to move backward to protrude from a rear surface of the door.

2. The refrigerator of claim 1, wherein when viewed from a side, the handle and the link overlap each other.

3. The refrigerator of claim 2, wherein when viewed from a side, the handle overlaps the center of rotation of the link.

4. The refrigerator of claim 2, wherein the operation part and the link are spaced apart from each other in the width direction of the door.

5. The refrigerator of claim 4, wherein the handle further comprises:
a body extending downward from the operation part; and
a handle arm disposed below the operation part and extending outward in the width direction of the door from the body.

6. The refrigerator of claim 5, wherein the rotating shaft of the link is disposed in the width direction of the door, and a length of the rotating shaft of the link in the width direction of the door is greater than a width of the first arm.

7. The refrigerator of claim 6, wherein the handle further comprises a step portion protruding forward from the handle arm,
wherein the lifter protrudes outward in the width direction of the door from the step portion.

8. The refrigerator of claim 1, wherein the opening module further comprises a stopper disposed at an upper side of the operation part and configured to restrict upward movement of the handle.

9. The refrigerator of claim 1, wherein the link further comprises a protrusion protruding rearward from the second arm to contact the pusher.

10. The refrigerator of claim 1, wherein the opening module further comprises a case disposed inside the door and configured to accommodate the handle and the link.

11. The refrigerator of claim 10, wherein the door further comprises:
a front panel defining a front surface of the door; and
an opening formed in the front panel and communicating with the accommodation space,
wherein the case covers the opening from the inside of the door.

12. The refrigerator of claim 10, wherein the opening module further comprises an elastic member pressing the pusher forward,
wherein the pusher comprises:
an inner portion having an accommodation portion in which the elastic member is disposed;
an outer portion protruding rearward from the rear surface of the door when the pusher moves backward; and
an extension portion extending from the inner portion to the outer portion,
wherein the elastic member is disposed between the case and the accommodation portion.

13. The refrigerator of claim 1, wherein the lever comprises an insertion portion into which the lifter is inserted, and
wherein the insertion portion extends forwardly and downwardly.

14. The refrigerator of claim 13, wherein the opening module further comprises an elastic member pressing the pusher forward,
wherein the lifter is disposed at a front end of the insertion portion when no external force is applied to the opening module.

15. A refrigerator comprising:
a cabinet defining a storage space open forward;
a door disposed at a front of the cabinet and configured to open and close the storage space; and
an opening module disposed inside the door,
wherein the opening module comprises:
a handle movable upward and downward;
a link rotatable about a center of rotation disposed in a width direction of the door upon upward and downward movement of the handle; and
a pusher movable forward and backward upon rotation of the link, and configured to move backward and protrude from a rear surface of the door,
wherein when viewed from a side, the handle and the link overlap each other.

16. The refrigerator of claim 15, wherein the handle comprises a lifter disposed below the link, and the link comprises a lever disposed above the lifter and inclined forward and downward.

17. The refrigerator of claim 15, wherein the handle comprises an operation part accessible from an outside,
wherein when viewed from a side, the operation part and the link overlap each other and are spaced apart from each other in the width direction of the door.
